(19) United States
(12) Patent Application Publication
(10) Pub. No.: US 2025/0188220 A1
(43) Pub. Date: Jun. 12, 2025

(54) NYLON COMPOSITIONS

(71) Applicant: SCI-LUME LABS, INC., Edmond, OK (US)

(72) Inventor: Oliver SHAFAAT, Edmond, OK (US)

(21) Appl. No.: 18/838,848

(22) PCT Filed: Feb. 15, 2023
(86) PCT No.: PCT/US2023/062672

§ 371 Date: Aug. 15, 2024

Related U.S. Application Data
(60) Provisional application No. 63/310,758, filed on Feb. 16, 2022.

(51) Int. Cl. C08G 69/24; C08G 69/48

(52) U.S. Cl. CPC C08G 69/24; C08G 69/48; C08G 2230/00

(57) ABSTRACT

A polyamide comprises a plurality of amide units forming a polymer chain, and an alkyl substituent on the amide group. The polyamide has a substitution of the amide units in an amount of between about 0.1% to about 10% of the amide units in the polymer chain. A method of forming a polyamide composition includes providing a that includes a plurality of amide groups in a backbone structure of the polyamide, and modifying a portion of the plurality of amide groups in the backbone structure with one or more alkyl substituents to form the polyamide composition. The polyamide has a substitution of the amide units in an amount of between about 0.1% to about 10% of the amide units in the backbone.

### CROSS-REFERENCE TO RELATED APPLICATIONS

This application claims priority to and the benefit of U.S. Provisional Patent Application No. 63/310,758 filed on Feb. 16, 2022, and entitled, “NYLON COMPOSITIONS,” which is incorporated herein by reference in its entirety.

### BACKGROUND

Nylon can be produced by the polymerization of amide units, and the type of nylon produced can be referred to by the number of carbon atoms in the monomer unit being polymerized. Nylon may be less stable than other types of polymers (e.g., polyethylene) due to the presence of the amide units. The instability can include thermal instabilities that can make processing of the nylon difficult.

### SUMMARY

In some embodiments, a polyamide comprises a plurality of amide units forming a polymer chain, and an alkyl substituent on the amide group. The polyamide has a substitution of the amide units in an amount of between about 0.1% to about 10% of the amide units in the polymer chain.

In some embodiments, a poly-2-pyrrolidone polymer comprises a formula as follows:

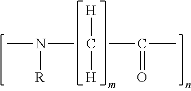

where m can be 3 and where R comprises an alkyl substituent on the amide group, and where the poly-2-pyrrolidone has a substitution of the amide group in an amount of between about 0.1% to about 10% of the amide groups in the poly-2-pyrrolidone.

In some embodiments, a method of forming a polyamide composition comprises: providing a polyamide, wherein the polyamide comprises a plurality of amide groups in a backbone structure of the polyamide, and modifying a portion of the plurality of amide groups in the backbone structure with one or more alkyl substituents to form the polyamide composition. The polyamide has a substitution of the amide units in an amount of between about 0.1% to about 10% of the amide units in the backbone.

These and other features will be more clearly understood from the following detailed description taken in conjunction with the accompanying drawings and claims.

### DETAILED DESCRIPTION

Various Nylons or polyamides can be modified to provide useful polymers. For example, poly-2-pyrrolidone can be produced by the alkaline-catalyzed polymerization of 2-pyrrolidone in the presence of various compounds such as carbon dioxide. The resulting polymer can be referred to in some contexts as Nylon 4 based on the polymerization of monomer contain 4 carbon atoms. Additional modifications can be used to alter the properties (e.g., melting temperature, degradation temperature, molecular weight, functionalization, etc.) of the polypyrrolidone, and the resulting material can show improved biodegradation relative to other polymers such as olefin-based polymers including polyethylene, polypropylene, and the like. To the extent that articles can be formed from degradable materials, the environmental persistence of such polymers can be reduced relative to other polymers.

The resulting polypyrrolidone can be formed into various forms and products to allow for a variety of end uses including sheets, films, filaments, ribbons, molded articles, and fibers. Because of its hydrophilic properties, which closely resemble those of cotton and silk, polypyrrolidone fiber has long been recognized as having great commercial potential. For example, fabrics made from polypyrrolidone, in contrast with other presently available synthetic fibers, are as readily dyed as cotton, they may be ironed at cotton temperatures, they rapidly dissipate static charges, and, in particular, they possess the comfort of cotton, silk, and wool.

The biodegradability is balanced with the ability to form useful articles from the polymers. To form filaments and fibers, the polymer can be melt-spun into filaments by extrusion from spinnerets. In melt-spinning, the polymer composition is extruded in a molten condition at a melt temperature which is generally greater than about 270° C. This extrusion must be carried out with care because of the thermal degradation of the polymer, which can cause the polymer to revert back to monomer. As well as causing substantial product loss and increasing process cost, this can also cause bubbles and the formation of voids or pox marks in the extrudate or filaments. Moreover, in addition to monomer reversion, molecular weight degradation also occurs during melt spinning resulting in poly-2-pyrrolidone filaments having substantially lower molecular weights than the original polymer. If the molecular weight of the initial polymer is too low or if the molecular weight degradation is too severe, the molecular weight of the filaments will be inadequate to afford the filaments sufficient tensile strength and fibrillation properties.

In addition to melt-spinning, solution-spinning is a method for the formation of useful articles from the polymer. If solution spinning is used the polymer is dissolved in a solvent to a high concentration, commonly called a dope, and then extruded into a non-solvent where precipitation occurs and the articles are formed. Typical concentrations for dope solutions can be between 2.5 wt %-50 wt %, resulting in high-viscosity solutions of the range of 1000 centipoise to 1,000,000 centipoise or higher, most preferably 5000 centipoise to 50,000 centipoise. Examples of solvents that can be used are acids, polar protic, polar aprotic, ionic liquids, fluorinated alcohols and the like.

A further problem is that higher molecular weight (e.g., about 120,000 and above) polymers, although thermally more stable, are also more viscous and more difficult to extrude. If extrusion is attempted at appreciably lower temperatures to avoid thermal decomposition, the material is not properly melted and fibers of substantially lower tensile strength are produced. Consequently, in order to melt extrude polypyrrolidone efficiently, the thermal stability of the polymer and/or to the extrudability of the polymeric composition can be improved.

In some aspects, a polypyrrolidone is disclosed herein that allows for the melting temperature to be lowered and/or the thermal stability to be increased, thereby improving the workability of the polymers. In some aspects, the disclosed methods and resulting polymers allow for the lowering of the melting point of the resulting polymer while not affecting the degradation temperature. Alternatively, raising the degradation temperature of the resulting polymer while not affecting the melting point is also possible. This can then allow the polymer to be more easily worked and formed into useful articles without degrading the polymer in the process.

This disclosure relates to various polyamide compositions that can be modified to improve the processability while maintaining a bio-degradability. While various nylons can be produced as provided herein, in some aspects a poly-2-pyrrolidone compositions that are modified to have improved thermal stabilities and to methods of treating poly-2-pyrrolidone to prepare the modified poly-2 pyrrolidone compositions are described as examples. Other polyamides such as Nylon 3, Nylon 4, Nylon 6, proteins, and other classes of nylons such as Nylon 2,2, Nylon 3,3, and the like can be similarly modified as provided herein to improve the properties including lowering the melting point and/or raising the degradation temperature. In general, the modification techniques described herein can be used on any suitable polyamide.

2-pyrrolidone can be polymerized to form the poly-2-pyrrolidone using any suitable techniques. Methods for the polymerization of 2-pyrrolidone to form poly-2-pyrrolidone, which can also simply be referred to as polypyrrolidone herein, can include the polymerization of 2-pyrrolidone in the presence of an alkaline polymerization catalyst, if desired with an activator. Cationic ring opening polymerization methods can also be used.

The polymer formed from 2-pyrrolidone is believed to be a linear polyamide, which has come to be known as nylon-4, having the structure:

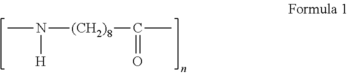

where n can range from about 200 to over 1,000,000, or in some aspects as high as 100,000. In some aspects, n may range as high as about 10,000, or about 5000 depending on the type of nylon considered. A more general formulation of a nylon formed from a generic starting material can include:

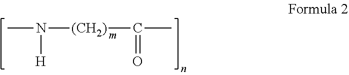

where when m is 1, the polyamide is nylon 2, when m is 2, the polyamide is nylon 3, when m is 3 the polyamide is nylon 4, n can be any of the values noted above for Formula 1, and R can by hydrogen or another alkyl modification as provided herein.

In some aspects, the polypyrrolidone can be prepared by polymerizing 2-pyrrolidone using an alkaline polymerization catalyst in the presence of carbon dioxide (CO₂). For example, polymerization can be effected by bubbling CO₂ through a mixture of 2-pyrrolidone and an alkali metal salt of 2-pyrrolidone, e.g., sodium or potassium pyrrolidonate, the alkali metal pyrrolidonate functioning as an alkaline polymerization catalyst. The polypyrrolidone can also be prepared by reacting CO₂ with the alkali metal salt of 2-pyrrolidone to form an adduct of CO₂ and the alkali metal pyrrolidonate, and then polymerizing the 2-pyrrolidone monomer in the presence of the adduct.

In some aspects, the polymerization of 2-pyrrolidone can be carried out using an alkaline polymerization catalyst in the presence of CO₂. The 2-pyrrolidone monomer may be polymerized at a temperature from 18° C. to about 100° C., preferably 25° C. to 70° C., and most preferably 25° C. to 60° C., under a pressure ranging from subatmospheric to superatmospheric in the presence of the alkaline polymerization catalyst. Bulk polymerization or suspension polymerization can be used.

The alkaline polymerization catalyst can be any of those used in polymerizing 2-pyrrolidone. Suitable alkaline polymerization catalysts are derivatives of the alkali metals, e.g. the hydroxides and oxides of the alkali metals, including potassium tert-butoxide. The alcoholates of the alkali metals, such as sodium methylate, may also be used. In addition, the oxides and hydroxides of the alkaline earth metals, for example, calcium and barium, may be used as catalysts. Also, organic metallic compounds, preferably those which are strongly basic, may be used, such as lithium, potassium and sodium alkyls, e.g. butyl lithium, and the aryls of the alkali metals, such as sodium phenyl and sodium amide. The alkaline polymerization catalyst may be a quaternary ammonium base. Still further, as previously mentioned, the catalyst may be an alkali metal hydride, such as sodium hydride. While certain alkali metal derivatives can be used, many of them are undesirable. For example, the alkali metal carbonates as well as the alkaline earth metal hydroxides tend to be insoluble and for this reason are undesirable. Lithium hydroxide (monohydrate) also is insoluble in 2-pyrrolidone.

In some aspects, a non-ionic base can also be used as a catalyst. For example, the polymerization can be catalyzed by strong, nitrogen- and phosphorous-containing non-ionic bases. The catalysts or initiators which are effective may include non-ionic bases with a pKa of equal to or greater than 30. Examples of non-ionic bases which are useful can include polyaminophosphazenes, including phosphazene bases of the structure:

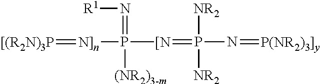

where R¹ is (C₁-C₈) alkyl wherein when alkyl is greater than C₃ it is branched or linear, and R is Me or both R's together are —(CH₂)₄—, and m, n, and y are independently 0-3 or preferably as defined below for the specific phosphazene Px (x=1 to 7) bases. Preferred R¹ groups include t-butyl, t-heptyl (—C(CH₃)₂ C(CH₂)₃) and t-octyl (—C(CH₃)₂ CH₂ C(CH₂)₃). Preferred R's are methyl and —(CH2)4-. When using a non-ionic base as a catalyst, the polymerization can be carried out at temperature of between about 25° C. to about 200° C. depending on the type of polyamide being polymerized. In general, the lower the monomer molecular weight, the lower the polymerization temperature would be.

The catalyst may be used in an amount of about 0.5 to about 50% by weight or higher, based on the 2-pyrrolidone monomer, preferably 5 to 30 wt. %, most preferably 8 to 20 wt. %.

The preferred proportions of CO₂ and alkaline polymerization catalyst has been found to be about 2 to about 20 mols of the catalyst per mol of CO₂, or alternatively between about 4 to about 10 mols of catalyst per mol of CO₂. The temperature at which the CO₂ is added to the catalyst may be varied widely, where results can be obtained at temperatures ranging from 18° C. (approximately the freezing point of the solution of the catalyst in monomer) to 130° C. or higher, or between about 40° C. to about 60° C.

In some aspects, an alkaline polymerization catalyst is the alkali metal salt of 2-pyrrolidone, e.g. sodium or potassium pyrrolidonate. When CO₂ is bubbled through a reaction mixture of 2-pyrrolidone monomer and the alkali metal pyrrolidonate catalyst, an adduct of CO₂ and alkali metal pyrrolidonate is formed. It has been found that this adduct can be used in the polymerization when alkali metal pyrrolidonate is also present.

The CO₂ can be bubbled through a mixture of the 2-pyrrolidone monomer and alkali metal pyrrolidonate in the ratio of about one-quarter to about one mol of CO₂ per mol of alkali metal pyrrolidonate, although more or less CO₂ can be used. If larger amounts of CO₂ are used, e.g. more than one-half mol of CO₂ per mol of alkali metal pyrrolidonate, the additional CO₂ may not be readily absorbed. If smaller amounts of CO₂ are used, e.g. 2 mols of alkali metal pyrrolidonate per 0.5 mol of CO₂ the reaction mixture will comprise 2-pyrrolidone monomer, alkali metal pyrrolidonate and the CO₂-alkali metal pyrrolidonate adduct. Good results are obtained in general, by stopping the addition of the CO₂ just short of absolute saturation, although this is not essential. Best results are obtained by using somewhat less than 1/2 mol of CO₂ per mol of alkali metal pyrrolidonate, such as a ratio of 1/4 to 3/8 mol of CO₂ per mol of the pyrrolidonate. In any case, the reaction mixture is then placed in a polymerization vessel to polymerize the monomer with or without further addition of CO₂. If desired the reaction between CO₂ and alkali metal pyrrolidonate can be carried out before contact with the bulk of the 2-pyrrolidone monomer.

While described herein as occurring in the presence of CO₂, the process can also occur without the addition of any CO₂, where the remaining components and conditions can remain the same. In the even that no CO₂ is added in the process, the polymerization will occur as described, but occurs over much longer timescales and to lower conversation rates.

In some aspects, the polymerization of 2-pyrrolidone can be carried out in the following manner. First, the 2-pyrrolidone monomer is reacted with an alkali metal hydroxide, preferably NaOH or KOH, the water formed in the reaction being removed by distillation, so as to form in situ an anhydrous solution of the alkali metal salt of the 2-pyrrolidone in the 2-pyrrolidone to be polymerized. Removal of the water can occur under sub-atmospheric conditions (e.g., at pressures below atmospheric pressure of 14.7 psia) and temperatures from 18° C. to 150° C., preferably between 25° C. to 100° C., and most preferably between 25° C. and 45° C. In the presence of water deleterious reactions can occur and cause ring-opening of 2-pyrrolidone monomer and inhibit the polymerization reaction. Instead of the alkali metal hydroxide, the alkali metal pyrrolidonate can be formed using an alkali metal alcoholate, preferably NaOCH₃ or KOCH₃ to form a solution of alkali metal pyrrolidonate in 2-pyrrolidone. Any source of alkali metal can be used to form the pyrrolidonate, provided that undesired by-products are not formed and that the sensitive pyrrolidone ring is not destroyed. Undesired by-products are those that act as polymerization inhibitors. Sodium metal is an example of a source of alkali metal that should not be used. After removal of water from the reaction mixture, CO₂ can be bubbled through to form the alkali metal pyrrolinate-CO₂ adduct in situ, thereby starting the polymerization. If desired, additional 2-pyrrolidone monomer can be added to the alkali metal pyrrolidonate solution before introduction of the CO₂ Suitably, the 2-pyrrolidone monomer can be contacted with 0.01 to 10 wt. % of CO₂ based on the weight of the 2-pyrrolidone monomer. For example, amounts 0.2 to 6 wt. %, based on the weight of the 2-pyrrolidone, or alternatively 0.5 to 3 wt. % can be used.

Alternatively, polymerization of 2-pyrroledione can occur by reaction of monomer with potassium tertbutoxide. This base, or similar bases, can be used in similar methods as those described above, where the conditions and components can otherwise be the same or similar. However, in the example of use of potassium tertbutoxide, removal of tertbutanol occurs, as opposed to water. Apart from that the reaction proceeds as described above.

The amount of carbon dioxide can also be expressed as a mol percent of the mols of alkaline polymerization catalyst. The amount of carbon dioxide would thus be from about 0.06 to 60 mol percent, based on the mols of the alkaline polymerization catalyst, but higher amounts, e.g. up to about 80 mol percent CO₂ based on the mols of alkaline polymerization catalyst have been used. Generally, the amount of CO₂ on a molar basis will be from 10 to 80 mol percent, based on the mols of alkaline polymerization catalyst.

It is possible to introduce CO₂ into the system other than by bubbling CO₂ into the mixture of 2-pyrrolidone and alkaline polymerization catalyst. For example, the source of CO₂ can be a compound that will transfer CO₂ to the mixture of 2-pyrrolidone monomer and alkaline polymerization catalyst, provided that the anion remaining after loss of CO₂ from the compound is not deleterious to the polymerization. Adducts of carbon dioxide and an alkali metal or quaternary ammonium pyrrolidonate can be added to a mixture of 2-pyrrolidone monomer and alkaline polymerization catalyst, as can adducts of CO₂ and an alkali metal or quaternary ammonium caprolactamate, with or without any CO₂ gas added to the system. These adducts are added to the system on the same weight basis as the CO₂. A convenient method for preparing the adducts is to bubble CO₂ through an anhydrous mixture of the pyrrolidonate and 2-pyrrolidone under vacuum until there is a sharp rise in pressure indicating that the CO₂ is no longer being readily absorbed. The adduct is precipitated by adding benzene or other organic precipitant to the solution. There is recovered from the precipitate a free flowing, nonhygroscopic, white powder. Alternatively, the organic precipitant can be added to an anhydrous solution of pyrrolidonate in 2-pyrrolidone before the CO₂ is bubbled through the solution, in which case the precipitate forms as the CO₂ is absorbed. Since it is necessary to react CO₂ with anhydrous pyrrolidonate, it is preferred to form the CO₂-pyrrolidonate adduct by adding CO₂ to an anhydrous solution of pyrrolidonate in 2-pyrrolidone, where the pyrrolidonate is formed in situ as described herein.

In a similar manner, the adduct of CO₂ and caprolactamate is formed by bubbling CO₂ through an anhydrous solution of caprolactamate in caprolactam and adding the organic precipitant before or after the CO₂ addition. Generally, when the caprolactamate is formed in situ, temperatures in excess of 90° C. are avoided.

In some aspects, carbon dioxide can be used as the sole polymerization activator, although other polymerization activators may be used in conjunction with carbon dioxide. Other activators which may be used in conjunction with carbon dioxide are acyl compounds, e.g., organic acyl peroxides, carboxylic acid anhydrides, lactones, lactides, N-acyl derivatives of lactams, acyl halides, and alcohol esters of carboxylic acids.

In addition, any of the following activators may be used: Carbon disulfide, N-substituted secondary amides, Cyanuric chloride, Organic isocyanates, Adipimide, N-iminopyrrolidones, N-monocarbonyl pyrrolidone and organic acid amide, Aromatic carbonyl and organic acid amide, Chlorine, bromine, N bromopyrrolidone, or N-chloropyrrolidone, NO₂ or organic nitrite, P₂O₅ and other oxides or Group V elements, N,N-disubstituted ureas, Halides and oxyhalides of sulfur and phosphorous, Oxides of Group VI elements, Halosilanes, Benzenephosphorus dichloride, benzene phosphorous oxychloride, phosphorous trichloride, thionyl chloride, and/or tetramethylammonium chloride. These activators can be used as a replacement for CO₂, or in addition to CO₂ for the polymerization reaction. They can be added before, or preferably after the addition of CO₂. For example, in the case of tetramethylammonium chloride, the CO₂ adduct is formed then tetramethylammonium chloride is added to the solution, mixed well, and the polymerization occurs.

In general, the polymerization can be performed in the substantial absence of water, although anhydrous conditions are not essential. For example, the amount of water may be less than about 1% by weight of the 2-pyrrolidone monomer, or alternatively less than about 0.1% by weight of the 2-pyrrolidone monomer. The 2-pyrrolidone used in the polymerization may be substantially pure. For example, the 2-pyrrolidone monomer be purified by fractional distillation under reduced pressure or by recrystallization or a combination of both.

The resulting polymerized polypyrrolidone can have the formula as shown above as formula 1. Other polyamides can also be used for modification herein, where the more general polyamide formula is shown in Formula 2. For example, nylon 3 can be made using a ring-opening polymerization beta-propiolactam using bases as described herein, or acrylamide can be polymerized to produce the polyamide. Similarly, Nylon-2 can be synthesized using the polymerization of glycine N-carboxyanhydride (NCA), as well as any other suitable methods. Other polyamides can be produced using any suitable methods.

In order to improve the stability of the resulting polypyrrolidone, the structure of the polypyrrolidone can be modified to some degree to alter the properties of the polymer. In some aspects, the amide groups on the backbone structure of the polypyrrolidone can be modified between about 0.1% to about 10%, or between about 0.2% to about 8%, or between about 0.5% and about 5%. As used herein the percentage modification refers to the number average modifications of the amide units or groups on the polypyrrolidone backbone.

The resulting substituted polypyrrolidone can have the following formula:

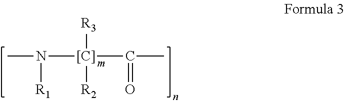

where n is as shown in formula 1, m is the same as in formula 1, and any of R₁, R₂, and R₃ can comprise a hydrogen or an alkyl substituent. Other substituents suitable for substitution as R can include methoxy, methylol, methyl-methoxy, and the like. In some aspects, this can result in R=MeOH, MeOMe, MeOEt, or MeOR. In various aspects, R can be any alkyl group using the appropriate substituent. In some aspects, the oxygen included in the repeating unit, sulfur can be incorporated or used to alter the polymer properties. While various methyl groups have been provided, the groups could also include EtOH, EtOMe, which is within the group defined by a alkyl group herein. The term “alkyl” as used herein can refers to both straight-chain and branched-chain alkyl groups and includes alkylene. Typical alkyl groups include for example methyl, methylene (—CH2-), ethyl, isopropyl, n-butyl, t-butyl, hexyl, decyl, tetradecyl, 4-methyl hexadecyl, eicosyl, and the like. The term alkyl includes lower alkyl groups where “lower alkyl” refers to alkyl groups having from 1 through 6 carbon atoms.

In some aspects, the R group can be a reactive group. For example, the R group can be an epoxy. isocyanate, or similarly reactive constituent. The ability to modify the backbone with such groups can be effected in the same manner as described herein, and the reactive groups can alter the chemistry of the resulting polymer.

As shown in Formula 2, the modifications can be associated with the amide group in the polypyrrolidone, and the remaining groups, including the carboxyl group may not be significantly modified, and in some aspects, the carboxyl group may have less than a 0.1% modification in the final polypyrrolidone composition.

The modification process of the polypyrrolidone can be effected by contacting poly-2-pyrrolidone (formula 1) with a base to deprotonate the amide backbone, followed by an alkylating agent under reactive conditions. Alternatively, or additionally, the polymer can be reacted with formaldehyde with or without exposure to alcohols or thiols, to modify the amide backbone. This process is typically conducted at temperatures in the range of about 18° C. to about 265° C., for about from 0.1 to about 120 hours. Typically, about from 0.1 to 10 moles of the modification agent are used per mole of the polypyrrolidone. The base polymer can be contacted as a finely divided powder in order to maximize contact of the polymer with the modification solution. Additionally, the base polymer can be dissolved in a suitable solvent for reaction. Such suitable solvents are organic acids such as formic acid, fluorinated alcohols (hexafluoroisopropanol), polar protic (DMF), polar aprotic (DMSO, DMAc, NMP), or any solvent in which both the polymer and reactants are soluble. Reaction rates are generally dependent upon temperature and thus lower reaction times can be used with higher reaction temperatures and vice versa. The degree of substitution can be controlled accordingly by adjusting the reaction times and temperatures as well as the above reaction conditions.

Suitable modification agents which can be used to modify the polypyrrolidone as described herein can include, but are not limited to, formaldehyde, paraformaldehyde, methyliodide, methanol, ethanol, sodium hydride, etc.

In some aspects, the polypyrrolidone can also be modified at one or more end caps, for example in addition to the backbone modifications. In these aspects, the polypyrrolidone can be reacted with certain alkanolamines or alkylenepolyamine [e.g., NH₂(CH₂)ₙNH₂] for a sufficient period of time to effect the desired capping. The end groups of the polypyrrolidone can be labile and open under very mild conditions, such as upon contact with water at room temperature.

The end capping can result in the capping of one or more ends such as any carboxyl end groups. Where direct capping of end groups is used the molecular weight of the product is close to (but, generally slightly less than) the weight average molecular weight of the starting material polymer. The capping process of the present invention can be effected by contacting polypyrrolidone before or after any backbone modifications with an alkanolamine temperature in the range of about from 20° C. to 100° C., preferably about from 25° C. to 80° C., for about from 0.5 to 50 hours preferably from about 1 to 30 hours.

The amount of capping agent can be selected to provide a desired amount of end capping. In some aspects, between one to two moles of capping agent can be used per mole of polymer. A molar ratio of 2:1 between the capping agent and the polypyrrolidone would theoretically result in both ends of the polypyrrolidone being capped. However, in some aspects an excess of the capping agent (e.g., greater than a 2:1 ratio of the capping agent to the polypyrrolidone) can be used to ensure adequate contact with the polymer. Thus, typically about from 2 to 10 grams, preferably about from 2 to 4 grams of capping agent can be used per gram of polymer. Alternatively, suitable inert organic diluents or inert organic solvents for the capping agent can also be advantageously used to reduce the amount of alkanolamine and/or alkylenediamine required to maximize polymer contact and facilitate handling.

Suitable alkanolamine capping agents which can be used can include, but are not limited to, alkanolamines having from 2 through 12 carbon atoms, preferably from 2 through 6 carbon atoms, and at least one hydroxy substituent and one amino substituent each substituted at different carbon atoms. The alkanolamine can also be optionally substituted with up to, and including a total of five hydroxy and/or amino substituents substituted at different carbon atoms. It is important that the carbon atom contains only a single substituent because compounds having carbon atoms having two amino or two hydroxy or an amino and a hydroxy substituent are unstable and would be expected to degrade either during the initial process and/or in polymer upon melt spinning. Suitable alkanolamines species which can be used include, for example, ethanolamine, 3-aminopropanol, 10-aminodecanol; 4-amino-2-ethyl-butanol; 2-hydroxy-4-aminobutanol, 2,4-diaminobutanol, 2-hydroxymethyl-5-aminopentanol, and the like.

Suitable alkylenepolyamines which can be used for the capping process can include, for example, alkylenepolyamines having 2 through 12 carbon atoms preferably 2 through 6 carbon atoms, substituted with 2 through 5 amino substituents each at different carbon atoms and optionally 1 through 3 hydroxy substituents each at different carbon atoms up to and including a total of 5 such substituents. Suitable alkylenepolyamine species include, for example, ethylenediamine, hexamethylenediamine, dodecylene diamine; 1,5-diamino-2-methylpentane; 1,2,4-triaminobutane; 1,5-diamino-3-hydroxyhexane; 1,2,6-triamino-4-3-hydroxyethylhexane, and the like. In terms of capped polymer product thermal stability for a given molecular weight, best results are generally obtained using alkanolamines and especially ethanolamine. Where an alkylenepolyamine is used, it is preferred to use an alkylenediamine such as ethylenediamine and hexamethylenediamine.

Additionally, various cyclic lactams can be used for the capping process, for example caprolactam, laurolactam, and others.

The end capping can result in improvements in thermal stability, which can facilitate the melt extrusion and particularly melt spinning of the compositions of the invention at temperatures in the range 260° C. to 285° C., or less than about 280° C., or below 275° C.

The modification of the polypyrrolidone can result in a modified polymer have a lower melting temperature. In some aspects, the melting temperature can be lowered relative to the base polypyrrolidone in an amount of between about 0.1 to about 20° C., or between about 1 to about 10° C.

The resulting modified polyproline can have a melting temperature of between about 220° C. and about 400° C., or between about 245° C. and about 260° C. In some aspects, the modified polyproline (e.g., based on backbone or end cap modifications) can have a degradation temperature at least about 200° C. or at least about 300° C., or alternatively between about 290° C. and about 330° C.

A temperature differential between the melting temperature and the degradation temperature can be expanded to allow for a greater range of temperatures to form useful articles. In some aspects, the temperature can differential can be between about 10° C. and about 60° C., which may be greater than the difference between the melting and degradation temperatures of the unmodified polypyrrolidone.

While described herein with respect to Nylon 4, any suitable polyamide composition can be modified as provided herein. Specifically, the same backbone and end capping processes can be used with other nylons such as Nylon 2, Nylon 3, Nylon 6, and the like. In some aspects, the modifications provided herein can be used with proteins. In some aspects, proteins can be seen as functionalized Nylon 2, and these compounds can be both sourced naturally and also made using new biotech techniques. The resulting chemistry of the proteins can follow that of the polypyrrolidone described herein. In general, the degradation temperature of Nylon 2, Nylon 3, and proteins may be below the melting point of these polymers. The use of the modification techniques as provided herein may allow the melting point to be lowered and/or the degradation temperature to be raised sufficiently to allow the polymers and proteins to be more easily processed using any of the processes described herein.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

Example 1: In this example, 0.5 g of polypyrrolidone was dissolved in 17 mL of formic acid at 60° C. 57 mg of paraformaldehyde was suspended in 680 mg of methanol at 60° C. An additional 680 mg of methanol was also incubated at 60° C. Upon complete dissolution of the polypyrrolidone into formic acid the paraformaldehyde solution was added in a rapid manner. The formic acid solution now containing polypyrrolidone, paraformaldehyde, and methanol was allowed to react at 60° C. for 5 minutes. At the end of this time the additional 680 mg of methanol was rapidly added to the solution and reacted for 30 minutes. Following the reaction time, the solution was added dropwise into 350 mL of cold acetone. The precipitate was then removed and soaked in 150 mL of clean acetone for 10 minutes, removed and dried at 50° C. The melting point of this sample was 259° C. with a degradation temperature of 313° C. The starting polypyrrolidone melting point temperature and degradation temperature was 267° C. and 288° C., respectively.

### Example 2

Example 2: Similar reaction conditions as Example 1 were used except that 100 mg of paraformaldehyde was suspended in 680 mg of methanol. Additionally, the reaction time after addition of the paraformaldehyde suspension was 10 minutes. This sample displayed a melting point temperature of 226° C. and a degradation temperature >304° C.

### Example 3

Example 3: The reactions conditions were similar as above except that 159 mg of paraformaldehyde was suspended in 680 mg of methanol. This sample displayed a melting point temperature of 218° C. and a degradation temperature of >303° C.

### Example 4

Example 4:1.07 g of polypyrrolidone was added to a vial containing 1.6 g of formic acid, 1.07 g of paraformaldehyde, and 5.4 mL of methanol. The vial was shaken by hand, sealed, and placed into an oven at 50° C. for 119 hours. The sample was then washed with excess 1:1 acetone:water, filtered, then washed with excess acetone. The sample was dried. This sample displayed a melting point temperature of 263° C., and a degradation temperature of 306° C.

### Example 5

Example 5: Polymerization of pyrroledione into polypyrrolidone occurred by mixing 11.2 g of pyrrolidone with 0.869 g of KOH at 110° C., under N₂, until complete dissolution of the KOH. The sample was then further stirred at least 10 minutes following complete dissolution. Dehydration occurred via short-path distillation; approximately 10% by volume was removed to ensure dryness. The reaction was then cooled to <60° C. under an N₂ atmosphere, following which CO₂ was bubbled through the solution to produce a cloudy yellow suspension. This was then placed in a scintillation vial and in an oven at 50° C. for at least 8 hours. Following the reaction, the solid polypyrrolidone was removed from the vial, mechanically crushed into small pieces, washed with excess water, and dried. The melting point temperature was 263° C.

### Example 6

Example 6: Similar polymerization conditions as Example 5, except after addition of CO₂ to the solution 1.422 g of tetramethylammonium chloride (pre-dried) was added and stirred for 5 minutes. This complete solution was then transferred to a vial, placed in an oven at 50° C. and reacted for at least 8 hours. Purification proceeded as Example 5. The melting point temperature of this sample was 264° C., with a degradation temperature of 282° C.

### Example 7

Example 7: The purified sample from Example 6 was dissolved in formic acid and precipitated in water. The sample was then filtered and washed with excess water to neutralize the solution. The polypyrrolidone was then dried. This sample has a melting point temperature of 266° C., with a degradation temperature of 299° C.

### Example 8

Example 8: Polymerization of pyrrolidone occurred as with Example 5 and 6, except in place of KOH, 1.477 g of potassium tert-butoxide was used. Following purification this sample had a melting point temperature of 267° C., with a degradation temperature of 285° C.

### Example 9

Example 9: Polymer from Example 8 was dissolved in formic acid and purified as in Example 7. This sample had a melting point of 264° C., with a degradation temperature of 294° C.

### Example 10

Example 10:1 g of polypyrrolidone was mixed with 3 g of ethanolamine. This vial was kept at 150° C. for 40 minutes. The vial was then cooled, and the polymer was washed with excess water and dried. This sample as a melting point temperature of 268° C., with a degradation temperature of 304° C.

### Example 11

Example 11: A sample of polypyrrolidone which has undergone melting point depression (Example 2) was then reacted with ethanolamine to alter the end capping (as in Example 10). This sample then showed a melting point temperature of 231° C., with a degradation point >321° C.

Having described certain compositions and methods, specific aspects can include, but are not limited to:

In a first aspects, a polyamide comprises a plurality of amide units forming a polymer chain; and an alkyl substituent on the amide group, wherein the polyamide has a substitution of the amide units in an amount of between about 0.1% to about 10% of the amide units in the polymer chain.

A second aspect can include the polyamide of the first aspect, wherein the polymer chain comprises end caps, and wherein at least a portion of the end caps comprise an alkyl substituent.

A third aspect can include the polyamide of the first or second aspect, wherein alkyl substituent is a methyl, ethyl, or butyl group.

A fourth aspect can include the polyamide of any one of the first to third aspects, wherein the polymer is biodegradable.

A fifth aspect can include the polyamide of any one of the first to fourth aspects, wherein the polymer is in the form of a sheet, a film, a filament, a ribbon, a molded article, a woven material, or a fiber.

A sixth aspect can include the polyamide of any one of the first to fifth aspects, wherein the polymer has a melting point of between 220° C. and about 400° C.

A seventh aspect can include the polyamide of any one of the first to sixth aspects, wherein the polymer has a degradation temperature of at least about 200° C.

An eighth aspect can include the polyamide of any one of the first to seventh aspects, wherein the polymer has a temperature difference between a melting temperature and a degradation temperature of at least about 20° C.

A ninth aspect can include the polyamide of any one of the first to fifth aspects, wherein the polyamide is Nylon 2, Nylon 3, Nylon 4, Nylon 6, or a protein.

In a tenth aspect, a poly-2-pyrrolidone polymer comprises a formula as follows:

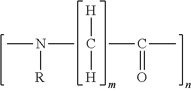

where m is 3 and where R comprises an alkyl substituent on the amide group, and where the poly-2-pyrrolidone has a substitution of the amide group in an amount of between about 0.1% to about 10% of the amide groups in the poly-2-pyrrolidone.

An eleventh aspect can include the polymer of the tenth aspect, wherein R is a methyl, ethyl, or butyl group.

A twelfth aspect can include the polymer of the eleventh aspect, wherein the polymer has a melting point of between 220° C. and about 400° C.

A thirteenth aspect can include the polymer of any one of the tenth to twelfth aspects, wherein the polymer has a degradation temperature of at least about 200° C.

A fourteenth aspect can include the polymer of any one of the tenth to thirteenth aspects, wherein the polymer has a temperature difference between a melting temperature and a degradation temperature of at least about 20° C.

A fifteenth aspect can include the polymer of any one of the tenth to fourteenth aspects, wherein the polymer is biodegradable.

A sixteenth aspect can include the polymer of any one of the tenth to fifteenth aspects, wherein the polymer is in the form of a sheet, a film, a filament, a ribbon, a molded article, a woven material, or a fiber.

In a seventeenth aspect, a method of forming a polyamide composition comprises: providing a polyamide, wherein the polyamide comprises a plurality of amide groups in a backbone structure of the polyamide; and modifying a portion of the plurality of amide groups in the backbone structure with one or more alkyl substituents to form the polyamide composition, wherein the polyamide has a substitution of the amide units in an amount of between about 0.1% to about 10% of the amide units in the backbone.

An eighteenth aspect can include the method of the seventeenth aspect, wherein the polyamide composition has a formal of:

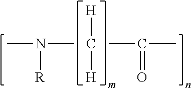

where R comprises an alkyl substituent on an amide group of the plurality of amide groups.

A nineteenth aspect can include the method of the seventeenth aspect, wherein the polyamide composition has the following formula:

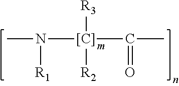

where n is between 200 and 100,000, m is 1-11, and any of R₁, R₂, and R₃ can comprise a hydrogen or an alkyl substituent.

A twentieth aspect can include the method of any one of the seventeenth to nineteenth aspects, where the carboxyl group in the polyamide has less than a 0.1% modification in the polyamide composition.

A twenty first aspect can include the method of any one of the seventeenth to twentieth aspects, wherein modifying the portion of the plurality of amide groups in the backbone structure with one or more alkyl substituents comprises: contacting the polyamide with a modification agent; deprotonating the portion of the plurality of amide groups; and alkylating the portion of the plurality of amide groups to form the polyamide composition.

A twenty second aspect can include the method of the twenty first aspect, wherein modifying the portion of the plurality of amide groups in the backbone structure with one or more alkyl substituents further comprises: dissolving the polyamide in a solvent prior to contacting the polyamide with the modification agent.

A twenty third aspect can include the method of the twenty first or twenty second aspect, wherein the modification agent comprises a base, formaldehyde, paraformaldehyde, methyliodide, methanol, ethanol, sodium hydride, or any combination thereof.

A twenty fourth aspect can include the method of any one of the seventeenth to twenty fifth aspects, wherein modifying the portion of the plurality of amide groups occurs at a temperature in a range of 18° C. to about 265° C., and for a time between about 0.1 to about 120 hours.

A twenty fifth aspect can include the method of any one of the seventeenth to twenty fourth aspects, further comprising: modifying a portion of the end caps of the polyamide composition.

A twenty sixth aspect can include the method of the twenty fifth aspect, wherein modifying the portion of the end caps comprises using capping agents to modify the end caps, wherein the capping agents comprise alkanolamines, alkylenepolyamine, cyclic lactams, or any combination thereof.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

What is claimed is:

1. A polyamide comprising:
a plurality of amide units forming a polymer chain; and
an alkyl substituent on the amide group, wherein the polyamide has a substitution of the amide units in an amount of between about 0.1% to about 10% of the amide units in the polymer chain.

2. The polyamide of claim 1, wherein the polymer chain comprises end caps, and wherein at least a portion of the end caps comprise an alkyl substituent.

3. The polyamide of claim 1, wherein alkyl substituent is a methyl, ethyl, or butyl group.

4. The polyamide of claim 1, wherein the polymer is biodegradable.

5. The polyamide of claim 1, wherein the polymer is in the form of a sheet, a film, a filament, a ribbon, a molded article, a woven material, or a fiber.

6. The polyamide of claim 1, wherein the polymer has a melting point of between 220° C. and about 400° C.

7. The polyamide of claim 1, wherein the polymer has a degradation temperature of at least about 200° C.

8. The polyamide of claim 1, wherein the polymer has a temperature difference between a melting temperature and a degradation temperature of at least about 20° C.

9. The polyamide of claim 1, wherein the polyamide is Nylon 2, Nylon 3, Nylon 4, Nylon 6, or a protein.

10. A poly-2-pyrrolidone polymer comprising:
a formula as follows: 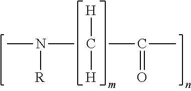
where R comprises an alkyl substituent on the amide group, and where the poly-2-pyrrolidone has a substitution of the amide group in an amount of between about 0.1% to about 10% of the amide groups in the poly-2-pyrrolidone.

11. The polymer of claim 10, wherein R is a methyl, ethyl, or butyl group.

12. The polymer of claim 10, wherein the polymer has a melting point of between 220° C. and about 400° C.

13. The polymer of claim 10, wherein the polymer has a degradation temperature of at least about 200° C.

14. The polymer of claim 10, wherein the polymer has a temperature difference between a melting temperature and a degradation temperature of at least about 20° C.

15. The polymer of claim 10, wherein the polymer is biodegradable.

16. The polymer of claim 10, wherein the polymer is in the form of a sheet, a film, a filament, a ribbon, a molded article, a woven material, or a fiber.

17. A method of forming a polyamide composition, the method comprising:
providing a polyamide, wherein the polyamide comprises a plurality of amide groups in a backbone structure of the polyamide;
modifying a portion of the plurality of amide groups in the backbone structure with one or more alkyl substituents to form the polyamide composition, wherein the polyamide has a substitution of the amide units in an amount of between about 0.1% to about 10% of the amide units in the backbone.

18. The method of claim 17, wherein the polyamide composition has a formal of: 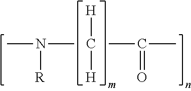
where R comprises an alkyl substituent on an amide group of the plurality of amide groups.

19. The method of claim 17, wherein the polyamide composition has the following formula: 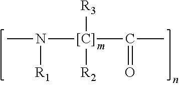
where n is between 200 and 100,000, m is 1-11, and any of R₁, R₂, and R₃ can comprise a hydrogen or an alkyl substituent.

20. The method of claim 17, where the carboxyl group in the polyamide has less than a 0.1% modification in the polyamide composition.

21. The method of claim 17, wherein modifying the portion of the plurality of amide groups in the backbone structure with one or more alkyl substituents comprises:
contacting the polyamide with a modification agent;
deprotonating the portion of the plurality of amide groups; and
alkylating the portion of the plurality of amide groups to form the polyamide composition.

22. The method of claim 21, wherein modifying the portion of the plurality of amide groups in the backbone structure with one or more alkyl substituents further comprises:
dissolving the polyamide in a solvent prior to contacting the polyamide with the modification agent.

23. The method of claim 21, wherein the modification agent comprises a base, formaldehyde, paraformaldehyde, methyliodide, methanol, ethanol, sodium hydride, or any combination thereof.

24. The method of claim 17, wherein modifying the portion of the plurality of amide groups occurs at a temperature in a range of 18° C. to about 265° C., and for a time between about 0.1 to about 120 hours.

25. The method of claim 17, further comprising:
modifying a portion of the end caps of the polyamide composition.

26. The method of claim 25, wherein modifying the portion of the end caps comprises using capping agents to modify the end caps, wherein the capping agents comprise alkanolamines, alkylenepolyamine, cyclic lactams, or any combination thereof.
